(19) United States
(12) Patent Application Publication
(10) Pub. No.: US 2022/0377766 A1
(43) Pub. Date: Nov. 24, 2022

(54) CONFIGURED UL WITH REPETITION

(71) Applicant: Telefonaktiebolaget LM Ericsson (publ), Stockholm (SE)

(72) Inventors: Reem Karaki, Aachen (DE); Min Wang, Luleå (SE)

(21) Appl. No.: 17/765,885

(22) PCT Filed: Sep. 2, 2020
(86) PCT No.: PCT/EP2020/074444

§ 371 Date: Apr. 1, 2022

Related U.S. Application Data
(60) Provisional application No. 62/910,914, filed on Oct. 4, 2019.

(51) Int. Cl. H04W 72/12; H04W 72/14; H04L 1/08; H04L 5/00

(52) U.S. Cl. CPC H04W 72/1268; H04W 72/14; H04L 1/08; H04L 5/0053

(57) ABSTRACT

A method for enabling Configured Uplink with repetition in a wireless communications system. In examples discussed herein, a wireless device (e.g., a user equipment) receives a configured number of repetitions from a base station (e.g., an eNB). Accordingly, the wireless device repeats a Transport Block (TB) corresponding to a Physical Uplink Shared Channel (PUSCH) transmission across an equal number of consecutive PUSCHs as the configured number of repetitions. As a result, the wireless device can support Configured Uplink with repletion, for example, when the repetition is configured for New Radio Unlicensed band (NR-U) Configured Uplink.

### RELATED APPLICATIONS

This application claims the benefit of provisional patent application Ser. No. 62/910,914, filed Oct. 4, 2019, the disclosure of which is hereby incorporated herein by reference in its entirety.

### TECHNICAL FIELD

The technology of the disclosure relates generally to enabling Configured Uplink with repetition in a wireless communications system.

### BACKGROUND

New Radio (NR) standard in 3GPP is being designed to provide service for a number of use cases, such as Enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for enabling low latency data transmission is to employ shorter transmission time intervals. In NR, in addition to transmission in a slot, a mini-slot transmission is also allowed to help reduce latency. A mini-slot may include anywhere from 1 to 14 Orthogonal Frequency Division Multiplexing (OFDM) symbols. It should be noted that the concept of slot and mini-slot is not specific to a specific service, meaning that a mini-slot may be used for either eMBB, URLLC, or other services as well.

Some related terminologies and/or definitions are provided below to help establish a context for the exemplary embodiments discussed later of the present disclosure.

### Resource Blocks

As illustrated in FIG. 1, in Rel-15 NR, a User Equipment (UE) can be configured with up to four carrier bandwidth parts in the downlink, with a single downlink carrier bandwidth part being active at a given time. A UE can be configured with up to four carrier bandwidth parts in the uplink, with a single uplink carrier bandwidth part being active at a given time. If a UE is configured with a supplementary uplink, the UE can in addition be configured with up to four carrier bandwidth parts in the supplementary uplink, with a single supplementary uplink carrier bandwidth part being active at a given time.

For a carrier bandwidth part with a given numerology, a contiguous set of Physical Resource Blocks (PRBs) are defined and numbered from 0 to N_{BWPi}^{size}−1, wherein i is an index of the carrier bandwidth part. A Resource Block (RB) is defined as 12 consecutive subcarriers in frequency domain.

### Numerologies

Multiple OFDM numerologies μ can be supported in NR as given by Table 1, wherein subcarrier spacing Δf and cyclic prefix for a carrier bandwidth part are configured by different higher layer parameters for downlink and uplink, respectively.

TABLE 1
Supported transmission numerologies.

| μ | Δf = 2^{μ} · 15 | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

### Physical Channels

A downlink physical channel corresponds to a set of resource elements carrying information originating from higher layers. The following downlink physical channels are defined:
Physical Downlink Shared Channel, PDSCH
Physical Broadcast Channel, PBCH
Physical Downlink Control Channel, PDCCH

PDSCH is the main physical channel used for unicast downlink data transmission, but also for transmission of Random Access Response (RAR), certain system information blocks, and paging information. PBCH carries the basic system information, required by the UE to access the network. PDCCH is used for transmitting Downlink Control Information (DCI), mainly scheduling decisions, required for reception of PDSCH, and for uplink scheduling grants enabling transmission on PUSCH.

An uplink physical channel corresponds to a set of resource elements carrying information originating from higher layers. The following uplink physical channels are defined:
Physical Uplink Shared Channel, PUSCH
Physical Uplink Control Channel, PUCCH
Physical Random Access Channel, PRACH

PUSCH is the uplink counterpart to the PDSCH. PUCCH is used by UEs to transmit uplink control information, including Hybrid Automatic Repeat Request (HARQ) acknowledgements, channel state information reports, etc. PRACH is used for random access preamble transmission.

### Frequency Resource Allocation for PUSCH and PDSCH

In general, a UE shall determine the RB assignment in frequency domain for PUSCH or PDSCH using the resource allocation field in the detected DCI carried in PDCCH. For PUSCH carrying msg3 in a random-access procedure, the frequency domain resource assignment is signaled by using the UL grant contained in RAR.

In NR, two frequency resource allocation schemes, type 0 and type 1, are supported for PUSCH and PDSCH. Which type of frequency resource allocation schemes to use for a PUSCH/PDSCH transmission may be defined by a Radio Resource Control (RRC) configured parameter or indicated directly in the corresponding DCI or UL grant in RAR (for which type 1 is used).

The RB indexing for uplink/downlink type 0 and type 1 resource allocation is determined within the UE's active carrier bandwidth part, and the UE shall upon detection of PDCCH intended for the UE determine first the uplink/downlink carrier bandwidth part and then the resource allocation within the carrier bandwidth part. The UL Bandwidth Part (BWP) for PUSCH carrying msg3 is configured by higher layer parameters.

### Cell Search and Initial Access Related Channels and Signals

For cell search and initial access, these channels are included: SS/PBCH block, PDSCH carrying Remaining Minimum System Information (RMSI)/RAR/MSG4 scheduled by PDCCH channels carrying DCI, Physical Random Access Channel (PRACH) channels and Physical Uplink Shared Channel (PUSCH) channel carrying MSG3.

Synchronization signal and PBCH block (SS/PBCH block, or SSB in shorter format) comprises the above signals (PSS, SSS and PBCH DMRS), and PBCH. SSB may have 15 kHz, 30 kHz, 120 kHz or 240 kHz SCS depending on the frequency range.

### PDCCH Monitoring

In 3GPP NR standard, DCI is received over the PDCCH. The PDCCH may carry DCI in messages with different formats. DCI format 0_0 and 0_1 are DCI messages used to convey uplink grants to the UE for transmission of the PUSCH and DCI format 1_0 and 1_1 are used to convey downlink grants for transmission of the PDSCH. Other DCI formats (2_0, 2_1, 2_2 and 2_3) are used for other purposes, such as transmission of slot format information, reserved resource, transmit power control information, and so on.

A PDCCH candidate is searched within a common or UE-specific search space which is mapped to a set of time and frequency resources referred to as a Control Resource Set (CORESET). The search spaces within which PDCCH candidates must be monitored are configured to the UE via RRC signaling. A monitoring periodicity is also configured for different PDCCH candidates. In any particular slot the UE may be configured to monitor multiple PDCCH candidates in multiple search spaces, which may be mapped to one or more CORESETs. PDCCH candidates may need to be monitored multiple times in a slot, once every slot or once in multiple of slots.

The smallest unit used for defining CORESETs is a Resource Element Group (REG), which is defined as spanning 1 PRB×1 OFDM symbol in frequency and time. Each REG contains Demodulation Reference Signals (DM-RS) to aid in the estimation of the radio channel over which REG was transmitted. When transmitting the PDCCH, a precoder may be used to apply weights at the transmit antennas based on some knowledge of the radio channel prior to transmission. It may be possible to improve channel estimation performance at the UE by estimating the channel over multiple REGs that are proximate in time and frequency if the precoder used at the transmitter for the REGs is not different. To assist the UE with channel estimation, the multiple REGs can be grouped together to form a REG bundle and the REG bundle size for a CORESET is indicated to the UE. The UE may assume that any precoder used for the transmission of the PDCCH is the same for all the REGs in the REG bundle. A REG bundle may include 2, 3, or 6 REGs.

A Control Channel Element (CCE) consists of 6 REGs. The REGs within a CCE may be contiguous or distributed in frequency. When the REGs are distributed in frequency, the CORESET is said to be using an interleaved mapping of REGs to a CCE. In contrast, if the REGs are not distributed in frequency, a non-interleaved mapping is said to be used.

Interleaving can provide frequency diversity, while not using interleaving may be beneficial for cases where knowledge of the channel allows the use of a precoder in a particular part of the spectrum to improve the SINR at the receiver.

A PDCCH candidate may span 1, 2, 4, 8, or 16 CCEs. If more than one CCE is used, the information in the first CCE is repeated in the other CCEs. Therefore, the number of aggregated CCEs used is referred to as the aggregation level for the PDCCH candidate.

A hashing function may be used to determine the CCEs corresponding to PDCCH candidates that a UE must monitor within a search space set. The hashing is done differently for different UEs so that the CCEs used by the UEs are randomized and the probability of collisions between multiple UEs for which PDCCH messages are included in a CORESET is reduced.

### Slot Structure

An NR slot includes several OFDM symbols. As an example, according to current agreements, either 7 or 14 symbols (OFDM subcarrier spacing ≤60 kHz) and 14 symbols (OFDM subcarrier spacing >60 kHz) may be included in the NR slot. FIG. 2 shows a subframe with 14 OFDM symbols. In FIG. 2, Tₛ and T_{symb} denote the slot and OFDM symbol duration, respectively.

The slot may be shortened to accommodate DL/UL transient period or both DL and UL transmissions. Potential variations are shown in FIG. 3.

Furthermore, NR also defines Type B scheduling (also known as mini-slots). Mini-slots are shorter than slots. As an example, according to current agreements, a mini-slot can include from 1 or 2 symbols up to the number of symbols in a slot minus one and can start at any symbol. Mini-slots are used if a transmission duration of a slot is too long or an occurrence of the next slot start (slot alignment) is too late. Applications of mini-slots include, among others, latency critical transmissions (in this case both mini-slot length and frequent opportunity of mini-slot are important) and unlicensed spectrum where a transmission should start immediately after listen-before-talk succeeded (here the frequent opportunity of mini-slot is especially important). An example of mini-slots is shown in FIG. 4.

### Configured UL

NR supports two types of pre-configured resources, which are different flavors of existing Long Term Evolution (LTE) semi-persistent scheduling with some further aspects such as supporting repetitions for a Transport Block (TB).
Type 1, UL data transmission with configured grant is only based on RRC (re)configuration without any L1 signaling.
Type 2 is very similar to LTE Semi-Persistent Scheduling (SPS) feature. UL data transmission with configured grant is based on both RRC configuration and L1 signaling for activation/deactivation of the grant. The gNB needs to explicitly activate the configured resources on PDCCH and the UE confirms the reception of the activation/deactivation grant with a Medium Access Control (MAC) control element.

### Time Resources for NR-U Configured UL

For configured grant time domain resource allocation, the mechanisms in Rel-15 (both Type 1 and Type 2) are extended so that the number of allocated slots following the time instance corresponding to the indicated offset can be configured. RAN1 is still discussing how to indicate multiple PUSCHs within a slot.

### HARQ for NR-U Configured UL

NR-U configured UL does not follow synchronous HARQ behavior as in the licensed NR. For every configured UL transmission, the UE selects HARQ, Redundancy Version (RV), and New Data Indicator (NDI) and reports it on the new NR-U Uplink Control Information (UCI).

NR, similar to eLAA Rel-14, does not support non-adaptive HARQ operation. Acknowledgement (ACK) feedback is implicit and Negative Acknowledgment (NACK) is explicit. A timer starts when a TB is transmitted, and if no explicit NACK (dynamic grant) is received before the timer expires, the UE would assume an ACK. This approach does not work well on the unlicensed carrier since an absence of a feedback might be due to failed Listen-Before-Talk (LBT). In this regard, a UE may misinterpret a delayed retransmission grant as being an ACK. Since the channel availability is not guaranteed on the unlicensed channel, the UE may run into this situation often.

For configured UL on NR-U, it is more suitable to follow the feLAA procedure, where ACK feedback is explicit and NACK is implicit. A timer starts when a TB is transmitted, and if no ACK is received before the timer expires the UE assumes NACK and performs non-adaptive retransmission. Non-adaptive retransmission can also be triggered by the reception of NACK on Downlink Feedback Information (NR-DFI). Additionally, the gNB may trigger an adaptive retransmission using a dynamic grant.

### RAN2 Agreements for NR-U Configured UL

The configured UL will support autonomous retransmission using a configured grant. To support autonomous retransmission in uplink using a configured grant, in RAN2-105bis, it was determined to introduce a new timer to protect the HARQ procedure so that the retransmission can use the same HARQ process for retransmission as for the initial transmission.
R2 assumes that the configured grant timer is not started/restarted when configured grant is not transmitted due to LBT failure. Protocol Data Unit (PDU) overwrite needs to be avoided somehow.
The configured grant timer is not started/restarted when UL LBT fails on PUSCH transmission for grant received by PDCCH addressed to CS-RNTI scheduling retransmission for configured grant.
The configured grant timer is not started/restarted when the UL LBT fails on PUSCH transmission for UL grant received by PDCCH addressed to C-RNTI, which indicates the same HARQ process configured for Configured Uplink grant.
Retransmissions of a TB using configured grant resources, when initial transmission or a retransmission of the TB was previously done using dynamically scheduled resources, is not allowed.
A new timer is introduced for auto retransmission (e.g., timer expiry=HARQ NACK) on configured grant for the case of the TB previous being transmitted on a configured grant “CG retransmission timer.”
The new timer is started when the TB is actually transmitted on the configured grant and stopped upon reception of HARQ feedback (DFI) or dynamic grant for the HARQ process.
The legacy configured grant timer and behavior is kept for preventing the configured grant overriding the TB scheduled by dynamic grant, for example, it is (re)started upon reception of the PDCCH as well as transmission on the PUSCH of dynamic grant.
At RAN2 #107, RAN2 has made below agreements:
The CG retransmission timer value is configured per configured grant configuration (e.g., ConfiguredGrantConfig) and the CG retransmission timer is maintained per HARQ process.
Autonomous retransmission on CG resource is prohibited for a HARQ process while the CG retransmission timer for the HARQ process is running.
Both CG timer and CG retransmission timer are used at the same time for a HARQ process.
The value of the CG retransmission timer is shorter than the value of the CG timer.
The CG timer is not restarted at autonomous retransmission on CG resource after the CG retransmission timer expiry.
The UE does not stop the CG timer upon NACK feedback reception but stops the CG timer upon ACK feedback reception.
On LBT failure at TX on CG, the UE transmits the pending TB using same HARQ process, in a CG resource.
CS-RNTI is used for scheduled retransmission, and C-RNTI is used for new transmission, similar to NR CG. To be confirmed by RAN1.
Collisions DG CG is FFS.

### Configured UL with Repetition

Repetition of a TB is also supported in NR, and the same resource configuration is used for K repetitions for a TB including the initial transmission. The higher layer configured parameters repK and repK-RV define the K repetitions to be applied to the transmitted transport block, and the redundancy version pattern to be applied to the repetitions. For an nth transmission occasion among K repetitions (n=1, 2, . . . , K), the nth transmission occasion is associated with (mod(n−1,4)+1)th value in the configured RV sequence. The initial transmission of a transport block may start at:
the first transmission occasion of the K repetitions if the configured RV sequence is {0,2,3,1}
any of the transmission occasions of the K repetitions that are associated with RV=0 if the configured RV sequence is {0,3,0,3}
any of the transmission occasions of the K repetitions if the configured RV sequence is {0,0,0,0}, except the last transmission occasion when K=8

For any RV sequence, the repetitions shall be terminated after transmitting K repetitions, or at the last transmission occasion among the K repetitions within the period P, or when a UL grant for scheduling the same TB is received within the period P, whichever is reached first. The UE is not expected to be configured with the time duration for the transmission of K repetitions larger than the time duration derived by the periodicity P.

For both Type 1 and Type 2 PUSCH transmissions with a configured grant, when the UE is configured with repK>1, the UE shall repeat the TB across the repK consecutive slots applying the same symbol allocation in each slot. If the UE procedure for determining slot configuration, as defined in subclause 11.1 of 3GPP TS 38.213, determines symbols of a slot allocated for PUSCH as downlink symbols, the transmission on that slot is omitted for multi-slot PUSCH transmission.

### Operation in Unlicensed Spectrum

For a node to be allowed to transmit in unlicensed spectrum (e.g., the 5 GHz band), it typically needs to perform a Clear Channel Assessment (CCA). This procedure typically includes sensing the medium to be idle for a number of time intervals. Sensing the medium to be idle can be done in different ways, for example, using energy detection, preamble detection, or using virtual carrier sensing. Where the latter implies that the node reads control information from other transmitting nodes informing when a transmission ends. After sensing the medium idle a node is typically allowed to transmit for a certain amount of time, sometimes referred to as Transmission Opportunity (TXOP). The length of the TXOP depends on regulation and type of CCA that has been performed, but typically ranges from 1 ms to 10 ms.

The mini-slot concept in NR allows a node to access the channel at a much finer granularity compared to LTE LAA, as an example, where the channel could only be accessed at 500 us intervals. Using for example 60 kHz subcarrier-spacing and a two-symbol mini-slot in NR, the channel can be accessed at 36 us intervals.

### SUMMARY

Embodiments disclosed herein include a method for enabling Configured Uplink with repetition in a wireless communications system. In examples discussed herein, a wireless device (e.g., a user equipment) receives a configured number of repetitions from a base station (e.g., an eNB). Accordingly, the wireless device repeats a Transport Block (TB) corresponding to a Physical Uplink Shared Channel (PUSCH) transmission across an equal number of consecutive PUSCHs as the configured number of repetitions. As a result, the wireless device can support Configured Uplink with repletion, for example, when the repetition is configured for New Radio Unlicensed Band (NR-U) Configured Uplink.

In one embodiment, a method performed by a wireless device for enabling Configured Uplink with repetition is provided. The method includes receiving a configured number of repetitions. The method also includes repeating a Transport Block (TB) corresponding to a Physical Uplink Shared Channel (PUSCH) transmission across an equal number of consecutive PUSCHs as the configured number of repetitions, wherein all of the consecutive PUSCHs have an identical length and fall within one or more Configured Grant-PUSCH (CG-PUSCH) transmission periods.

In another embodiment, receiving the configured number of repetitions further comprises receiving a Redundancy Version (RV) and repeating the TB corresponding to the PUSCH transmission comprises repeating the TB corresponding to the PUSCH transmission across the consecutive PUSCHs that fall within one CG-PUSCH transmission period.

In another embodiment, repeating the TB corresponding to the PUSCH transmission comprises starting an initial transmission of the TB at any occasion in the CG-PUSCH transmission period followed by the configured number of repetitions in accordance to the RV.

In another embodiment, the initial transmission of the TB corresponds to RV value zero, 0.

In another embodiment, repeating the TB corresponding to the PUSCH transmission further comprises repeating the TB when the configured grant is signaled via at least one of Radio Resource Control (RRC) signaling and Layer 1 (L1) signaling and the configured number of repetitions is greater than one.

In another embodiment, repeating the TB corresponding to the PUSCH transmission further comprises terminating the repetition of the TB corresponding to the PUSCH transmission in response to meeting one of the following conditions: repeating the TB corresponding to the PUSCH transmission for the configured number of repetitions; receiving an uplink grant for scheduling the TB within the CG-PUSCH transmission period; and receiving an explicit Acknowledgement for the TB.

In another embodiment, repeating the TB corresponding to the PUSCH transmission further comprises maintaining an identical New Data Indicator (NDI) across the configured number of repetitions.

In another embodiment, repeating the TB corresponding to the PUSCH transmission further comprises: starting/restarting a timer when the TB is transmitted or retransmitted; and performing non-adaptive retransmission in response to not receiving an Acknowledgement at an expiration of the timer.

In another embodiment, the method further comprises starting/restarting the timer in accordance to one or more of the following options: starting the timer immediately upon a first PUSCH repetition transmission and restarting the timer after each subsequent PUSCH repetition transmission; not starting the timer until a last PUSCH repetition transmission; starting the timer immediately after the last PUSCH repetition transmission within the CG-PUSCH transmission period; not starting the timer until there is a specific number of PUSCH repetition transmissions among the configured number of repetitions; and starting the timer after the first PUSCH repetition transmission after expiration of a time period.

In another embodiment, the method further comprises using a next repetition among the configured number of repetitions for retransmission of the TB upon the expiration of the timer.

In one embodiment, a wireless device is provided. The wireless device includes processing circuitry configured to perform any of the steps performed by the wireless device in any of the previous embodiments. The wireless device also includes power supply circuitry configured to supply power to the wireless device.

In another embodiment, a method performed by a base station for enabling Configured Uplink with repetition is provided. The method includes providing a configured number of repetitions to a wireless device. The method also includes receiving, from the wireless device, repetition of a TB corresponding to a PUSCH transmission across an equal number of consecutive PUSCHs as the configured number of repetitions, wherein all of the consecutive PUSCHs have an identical length and fall within one or more CG-PUSCH transmission periods.

In another embodiment, providing the configured number of repetitions comprises providing an RV and receiving repetition of the TB corresponding to the PUSCH transmission comprises receiving the TB corresponding to the PUSCH transmission across the consecutive PUSCHs that fall within one CG-PUSCH transmission period.

In another embodiment, receiving the repetition of the TB corresponding to the PUSCH transmission comprises receiving an initial transmission of the TB at any occasion in the CG-PUSCH transmission period followed by the configured number of repetitions in accordance to the RV.

In another embodiment, the initial transmission of the TB corresponds to RV value zero, 0.

In another embodiment, receiving the repetition of the TB corresponding to the PUSCH transmission further comprises receiving the repetition of the TB when the configured grant is signaled via at least one of RRC signaling and L1 signaling and the configured number of repetitions is greater than one.

In another embodiment, receiving the repetition of the TB corresponding to the PUSCH transmission further comprises stopping receiving the repetition of the TB corresponding to the PUSCH transmission in response to meeting one of the following conditions: receiving the repetition of the TB from the wireless device for the configured number of repetitions; providing an uplink grant to the wireless device for scheduling the TB within the CG-PUSCH transmission period; and providing an explicit Acknowledgement to the wireless device for the TB.

In another embodiment, receiving the repetition of the TB corresponding to the PUSCH transmission further comprises receiving an identical NDI across the configured number of repetitions.

In one embodiment, a base station is provided. The base station includes a control system configured to perform any of the steps performed by the base station in any of the previous embodiments.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an exemplary illustration of radio resources in New Radio (NR) systems;

FIG. 2 is an exemplary illustration of a slot in the NR systems;

FIG. 3 is an exemplary illustration of possible slot variations;

FIG. 4 is an exemplary illustration of a mini-slot with two Orthogonal Frequency Division Multiplex (OFDM) symbols;

FIG. 5 is a flowchart of an exemplary process for enabling NR Unlicensed Spectrum (NR-U) Configured Uplink with repetition;

FIG. 6 illustrates one example of a cellular communications system in which embodiments of the present disclosure may be implemented;

FIG. 7 is a flowchart of an exemplary method performed by a wireless device for enabling Configured Uplink with repetition;

FIG. 8 is a flowchart of an exemplary method performed by a base station for enabling Configured Uplink with repetition;

FIG. 9 is a schematic block diagram of a radio access node according to some embodiments of the present disclosure;

FIG. 10 is a schematic block diagram that illustrates a virtualized embodiment of the radio access node according to some embodiments of the present disclosure;

FIG. 11 is a schematic block diagram of the radio access node according to some other embodiments of the present disclosure;

FIG. 12 is a schematic block diagram of a wireless communication device according to some embodiments of the present disclosure;

FIG. 13 is a schematic block diagram of the wireless communication device according to some other embodiments of the present disclosure;

FIG. 14 is a schematic block diagram of a communication system in accordance with an embodiment of the present disclosure;

FIG. 15 is a schematic block diagram of UE, base station, and host computer discussed in the preceding paragraphs in accordance with an embodiment of the present disclosure;

FIG. 16 is a flowchart illustrating a method implemented in a communication system in accordance with one embodiment of the present disclosure; and

FIG. 17 is a flowchart illustrating a method implemented in a communication system in accordance with one embodiment of the present disclosure.

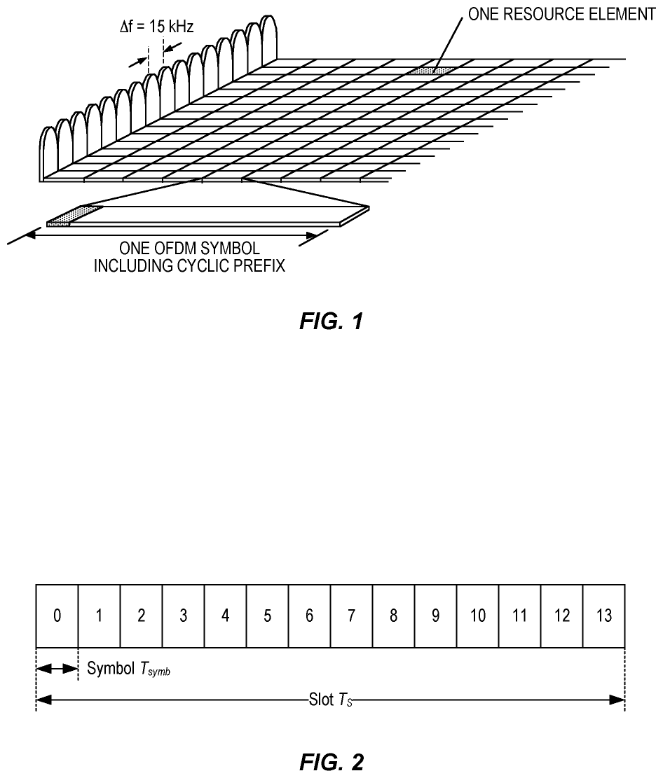

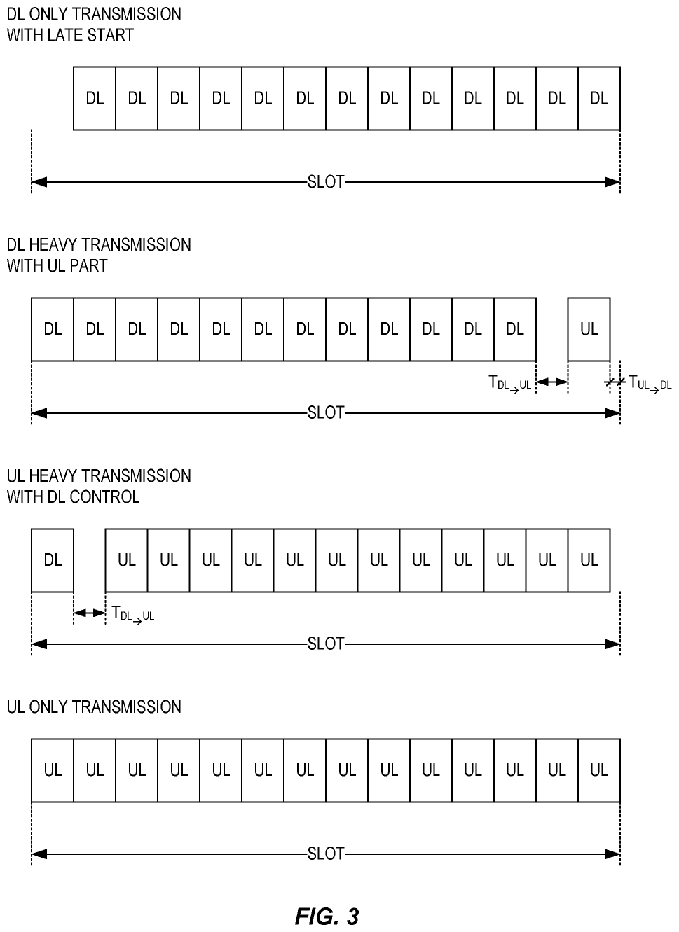

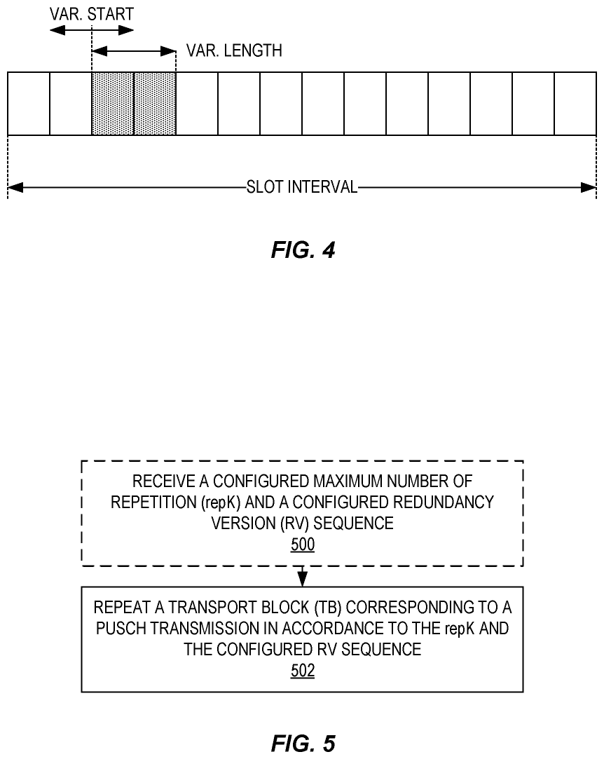

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist a certain challenge(s). The Configured Uplink with repetition mechanism as described above may not be used as is for NR operation in New Radio Unlicensed Band (NR-U), especially after the extension of the Configured Uplink time resources to a set of slots in every time period instead of one slot every time period. New rules should be defined to specify UE behavior when repetition is configured for NR-U Configured Uplink.

Certain aspects and embodiments of the present disclosure may provide solutions to the aforementioned or other challenges. Embodiments of a method for enabling NR-U Configured Uplink with repetition are provided. More specifically, embodiments disclosed herein include various embodiments for repeating a transport block (TB) corresponding to a transmitted Physical Uplink Shared Channel (PUSCH) in accordance to a configured maximum number of repetitions and a configured redundancy version (RV) sequence.

There are, proposed herein, various embodiments which address one or more of the issues disclosed herein. In one aspect, a method performed by a wireless device for enabling New Radio Unlicensed spectrum (NR-U) Configured Uplink with repetition is provided. As illustrated in FIG. 5 (where optional steps are represented by dashed lines/boxes), the method includes receiving (500) a configured maximum number of repetitions (repK) and a configured RV sequence, e.g., via a UE-specific signaling (e.g., UE-specific Radio Resource Control (RRC) signaling). The method also includes repeating (502) a TB corresponding to a PUSCH transmission in accordance to the configured repK and the configured RV sequence.

Certain embodiments may provide one or more of the following technical advantage(s). The method discussed herein sets new rules that specify UE behavior when repetition is configured for NR-U configured UL. These new rules may help eliminate ambiguity with respect to Hybrid Automatic Repeat Request (HARQ) process and the repetition index.

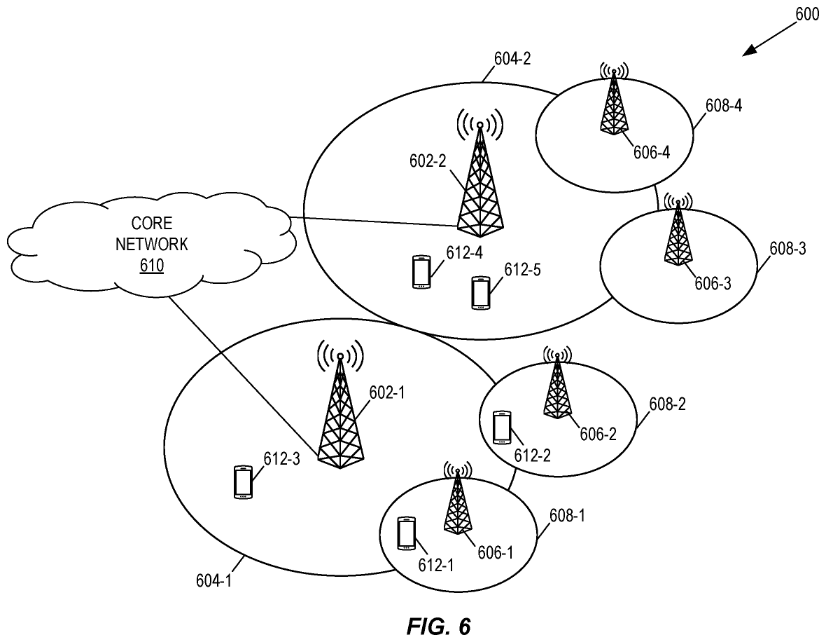

FIG. 6 illustrates one example of a cellular communications system 600 in which embodiments of the present disclosure may be implemented. In the embodiments described herein, the cellular communications system 600 is a 5G system (5GS) including a NR RAN or LTE RAN (i.e., E-UTRA RAN). In this example, the RAN includes base stations 602-1 and 602-2, which in 5G NR are referred to as gNBs (e.g., LTE RAN nodes connected to 5GC, which are referred to as gn-eNBs), controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is referred to as the 5G core (5GC). The base stations 602 (and optionally the low power nodes 606) are connected to the core network 610.

The base stations 602 and the low power nodes 606 provide service to wireless communication devices 612-1 through 612-5 in the corresponding cells 604 and 608. The wireless communication devices 612-1 through 612-5 are generally referred to herein collectively as wireless communication devices 612 and individually as wireless communication device 612. In the following description, the wireless communication devices 612 are oftentimes UEs, but the present disclosure is not limited thereto.

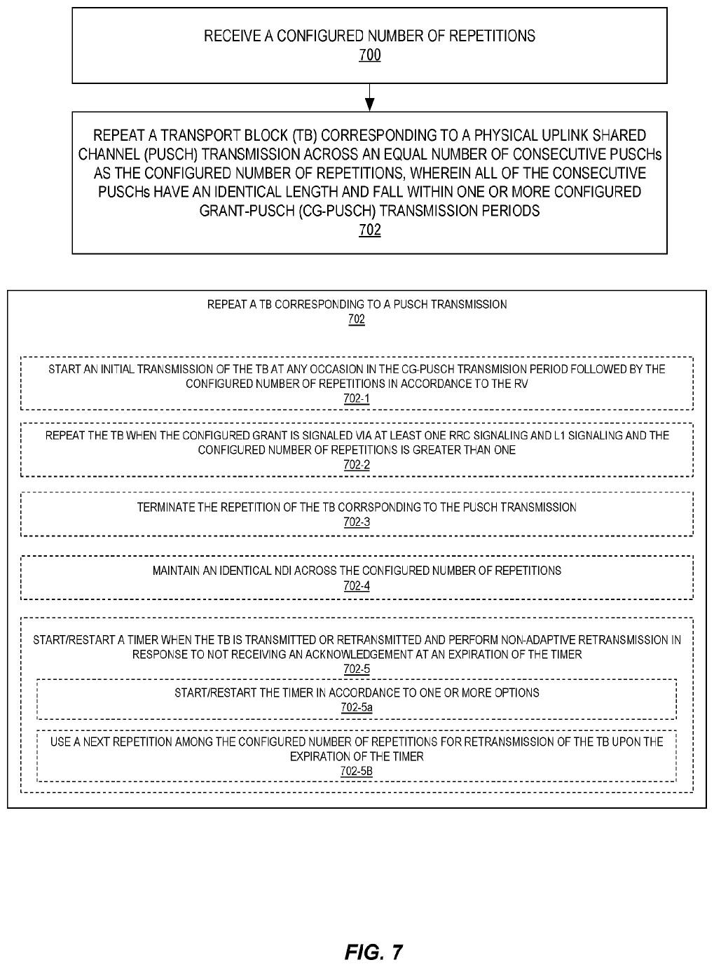

FIG. 7 is a flowchart of an exemplary method performed by a wireless device for enabling Configured Uplink with repetition according to an embodiment of the present disclosure. In this regard, a wireless device (e.g., a UE) receives a configured number of repetitions (step 700). Accordingly, the wireless device repeats a TB corresponding to a PUSCH transmission across an equal number of consecutive PUSCHs as the configured number of repetitions (step 702). Notably, all of the consecutive PUSCHs have an identical length and fall within one or more Configured Grant-PUSCH (CG-PUSCH) transmission periods.

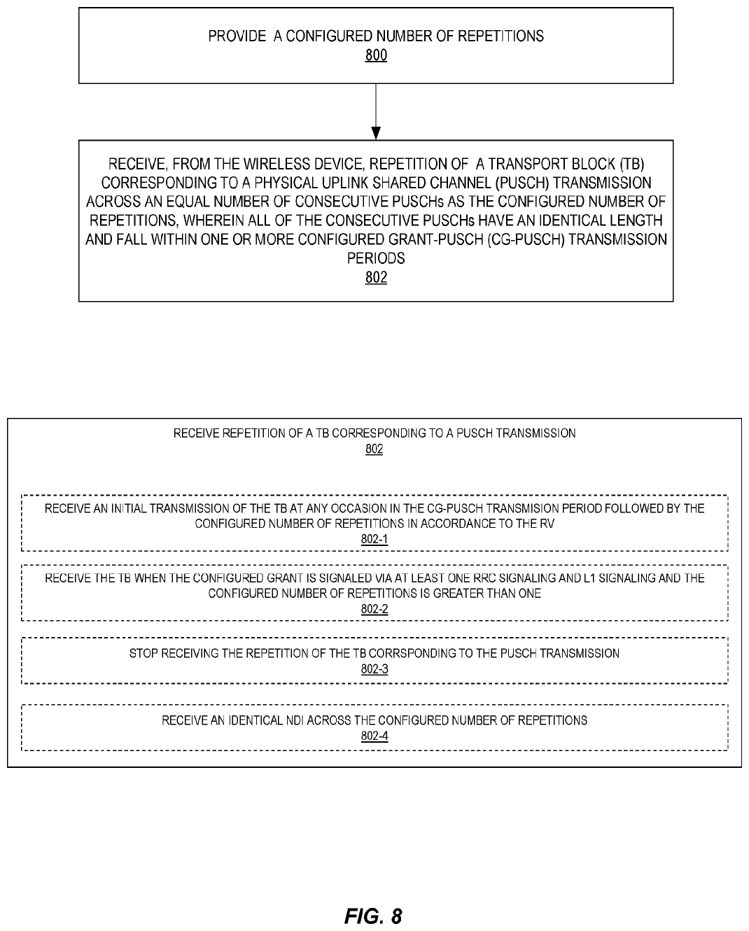

FIG. 8 is a flowchart of an exemplary method performed by a base station for enabling Configured Uplink with repetition. In this regard, a base station (e.g., an eNB) provides a configured number of repetitions to a wireless device (step 800). Accordingly, the base station receives, from the wireless device, repetition of a TB corresponding to a PUSCH transmission across an equal number of consecutive PUSCHs as the configured number of repetitions (step 802). Notably, all of the consecutive PUSCHs have an identical length and fall within one or more CG-PUSCH transmission periods.

Repetition of TB is not precluded in NR-U. In NR Rel-15, repetition of a TB is supported only across slots, and the same time-domain resource is used for K repetitions for a TB including the initial transmission. Additionally, repetition is only allowed within the same period of UL transmission with configured grant and should not cross to the next transmission period.

For NR-U, the above-mentioned constraints should be relaxed given that the RV is indicated in every CG-PUSCH, thus helping to eliminate ambiguity at the gNB side with respect to the HARQ process and the repetition index.

If repetition is configured, a UE should repeat a transmitted PUSCH according to a configured maximum number of repetitions and follow the RV sequence configured by UE-specific RRC signaling. Several exemplary embodiments are discussed below.

In a first embodiment, an initial transmission of a TB is allowed to be configured to start at any occasion in the CG-PUSCH window followed by K repetitions according to the configured RV sequence. The initial transmission of a TB may be configured to always correspond to RV 0. For instance, in regard to the PUSCH transmission of FIGS. 7 and 8, an initial transmission of the TB corresponding to the PUSCH transmission is allowed to be configured to start at any occasion in the CG-PUSCH window followed by K repetitions (i.e., the number of repetitions configured in steps 700 and 800 of FIGS. 7 and 8, respectively) according to the configured RV sequence.

In a second embodiment, the UE may repeat the TB across equal numbers of consecutive PUSCHs, as in step 702, based on one or more of the following options. For both Type 1 and Type 2 PUSCH transmissions with a configured grant, when a UE is configured with repK>1, at least one of the following alternatives may be applied:
Option 1: the UE shall repeat the TB across the repK consecutive slots within one CG-PUSCH window (e.g., the set of allocated slots for CG transmissions) with the same symbol allocation in each slot.
Option 2: the UE shall repeat the TB across the repK consecutive slots within one CG-PUSCH window and across consecutive CG-PUSCH windows with the same symbol allocation in each slot.
Option 3: the UE shall repeat the TB across the repK consecutive PUSCHs within the CG-PUSCH windows. All PUSCH are of the same length. The consecutive PUSCH are limited with one CG-PUSCH. Alternatively, the consecutive PUSCH can cross to the next CG-PUSCH transmission period.
Option 4: the UE shall repeat the TB across the repK non-consecutive PUSCHs within the CG-PUSCH windows. All PUSCH are of the same length. The two neighboring PUSCH occasions are separated by a time offset. The offset may be configured by the gNB or in the ConfiguredGrantConfig. As for which offset configuration is applied, it may be hard coded in the spec.
Alternatively, it may be configured for a UE by the gNB via signaling such as system information, dedicated RRC signaling, MAC CE or DCI. As another alternative, the option may be configured per ConfiguredGrantConfig. In this regard, a corresponding parameter indicating the Option may be included in ConfiguredGrantConfig.

In one aspect of this embodiment, repetition is allowed to cross to the next transmission period. Alternatively, the repetition is only allowed within the same period of UL transmission with configured grant and should not cross to the next transmission period. That is, the repetitions shall be terminated after at the last transmission occasion among the K repetitions within the period.

In a third embodiment, for any RV sequence, the repetitions shall be terminated after transmitting K repetitions, or when a UL grant for scheduling the same TB is received within the period P, or when an explicit ACK for the same TB is received via DFI, whichever is reached first. As such, the wireless device can ensure that the TB is repeated across an equal number of consecutive PUSCHs as the configured number of repetitions as in step 702.

In a fourth embodiment, the NDI value is the same for all the K repetitions. For example, if the first repetition indicates that NDI is equal to 1, the following remaining k−1 repetition indicates the same value. The NDI is toggled only for initial transmission of a transport block. In this regard, the wireless device can ensure that all of the consecutive PUSCHs have an identical length and fall within one or more Configured Grant-PUSCH (CG-PUSCH) transmission periods.

In a fifth embodiment, the timer (e.g., CGRT) may be started/restarted when a TB is transmitted/retransmitted. If no ACK is received before the timer expires, a UE may assume NACK and perform non-adaptive retransmission. In this regard, the wireless device can determine when to repeat the TB corresponding to the PUSCH transmission, as in step 702.

For a configured grant in which both the CGRT timer and repetition configurations (e.g., repK and repK-RV) are configured (e.g., present in the ConfiguredGrantConfig), if repetition is configured, the timer is started and restarted for a HARQ process with at least one of the following options:
Option 1: the CGRT timer is immediately started after the first PUSCH repetition transmission and restarted after every subsequent TB repetition transmission.
Option 2: the CGRT timer is not started until the last PUSCH repetition transmission is performed. In this regard, the timer is not started after transmission of the first repK−1 repetition transmissions.
Option 3: the CGRT timer is started immediately after the last PUSCH repetition transmission within an UL transmission period.
Option 4: the CGRT timer is not started until the Nth repetition transmission is performed, where N may be configured by the gNB, the configuration may also be included in the ConfiguredGrantConfig, where N<=repK. In this manner, the timer is not started after transmission of the first N−1 repetition transmissions. As soon as the timer is started, the timer will be restarted after every subsequent TB repetition.
Option 5: the CGRT timer is started after the first repetition transmission and a time period has expired. The time period may be configured by the gNB, and the configuration may also be included in the ConfiguredGrantConfig. As soon as the timer is started, the timer will be restarted after every subsequent TB repetition.

In a sixth embodiment, for a configured grant in which both the CGRT timer and repetition configurations (e.g., repK and repK-RV) are configured (e.g., present in the ConfiguredGrantConfig), if the CGRT timer is started/restarted after for a TB, the UE may use a next repetition occasion for retransmission of the TB upon expiry of the timer. In this regard, the wireless device can determine when to repeat the TB corresponding to the PUSCH transmission, as in step 702.

Now, some additional aspects that are applicable to all of the embodiments described above will be described.

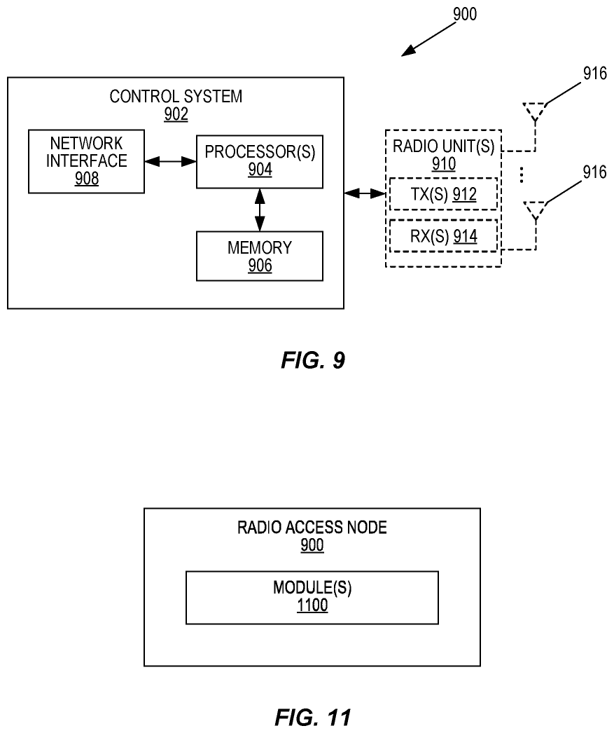

FIG. 9 is a schematic block diagram of a radio access node 900 according to some embodiments of the present disclosure. Optional features are represented by dashed boxes. The radio access node 900 may be, for example, a base station 602 or 606 or a network node that implements all or part of the functionality of the base station 602 or gNB described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

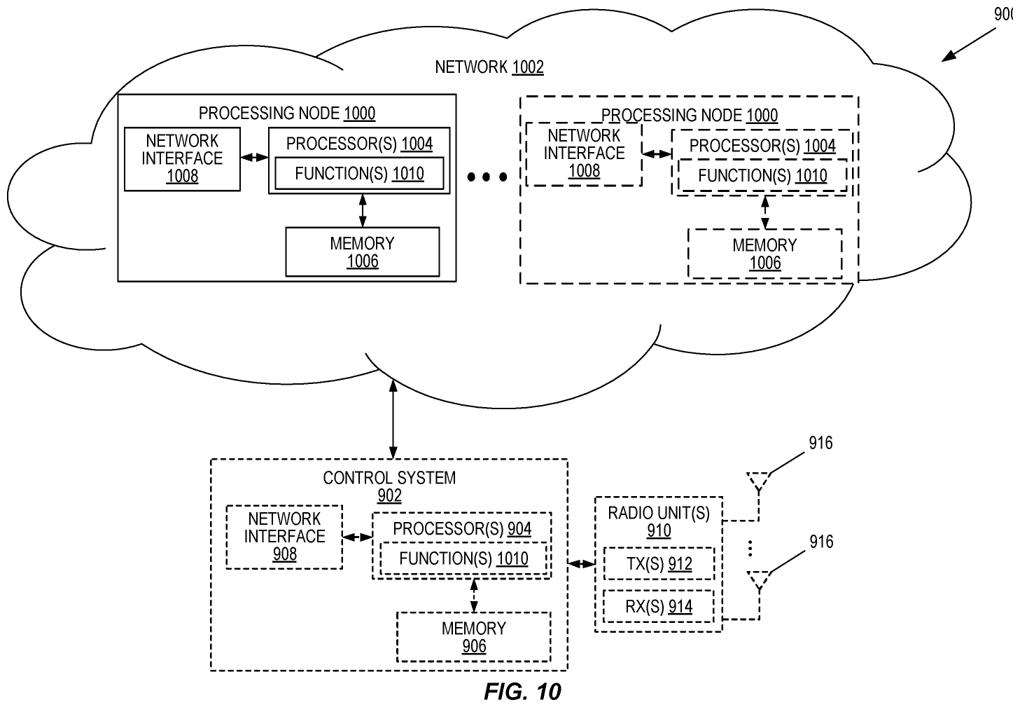

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) 910 is connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the one or more processing nodes 1000 and the control system 902 and/or the radio unit(s) 910 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicates directly with the processing node(s) 1000 via an appropriate network interface(s).

In some embodiments, a computer program including instructions which, when executed by at least one processor, causes the at least one processor to carry out the functionality of the radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

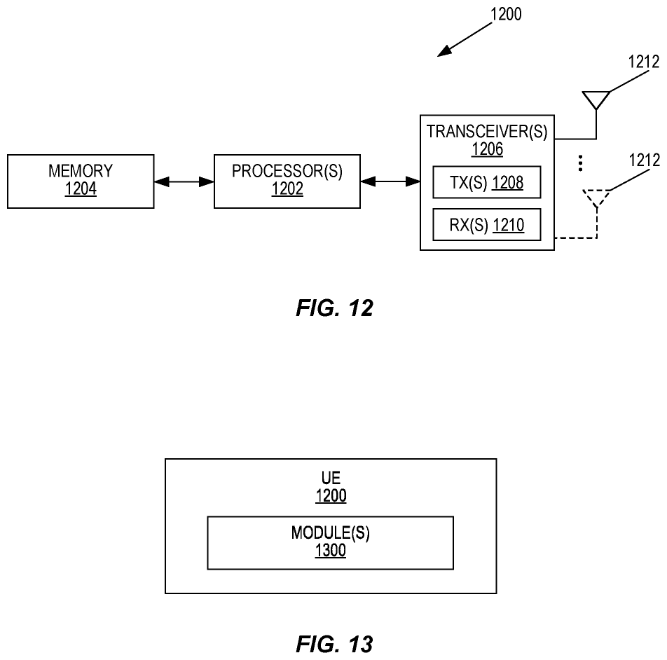

FIG. 12 is a schematic block diagram of a wireless communication device 1200 according to some embodiments of the present disclosure. As illustrated, the wireless communication device 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by one of ordinary skill in the art. The processors 1202 are also referred to herein as processing circuitry. The transceivers 1206 are also referred to herein as radio circuitry. In some embodiments, the functionality of the wireless communication device 1200 described above may be fully or partially implemented in software that is, e.g., stored in the memory 1204 and executed by the processor(s) 1202. Note that the wireless communication device 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the wireless communication device 1200 and/or allowing output of information from the wireless communication device 1200), a power supply (e.g., a battery and associated power circuitry), etc.

In some embodiments, a computer program including instructions which, when executed by at least one processor, causes the at least one processor to carry out the functionality of the wireless communication device 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the wireless communication device 1200 according to some other embodiments of the present disclosure. The wireless communication device 1200 includes one or more modules 1300, each of which is implemented in software. The module(s) 1300 provides the functionality of the wireless communication device 1200 described herein.

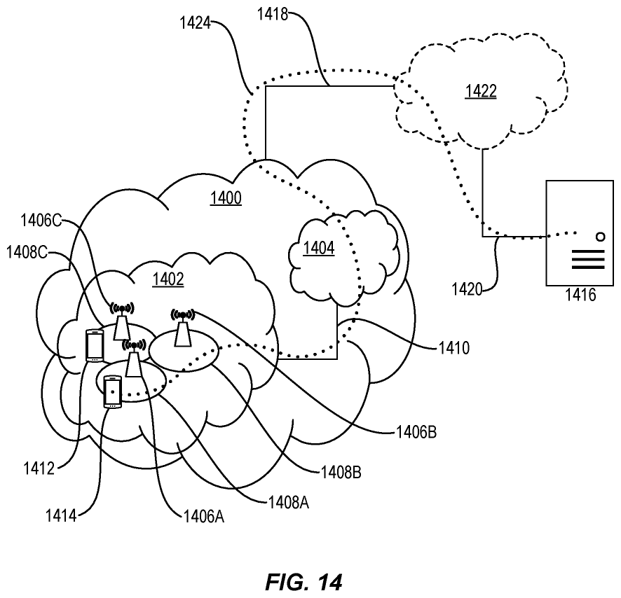

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

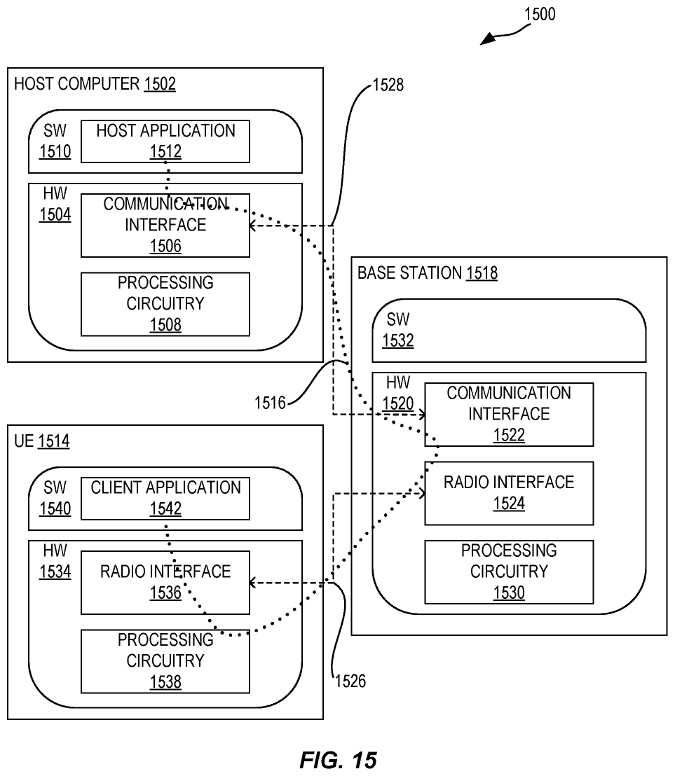

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502's measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

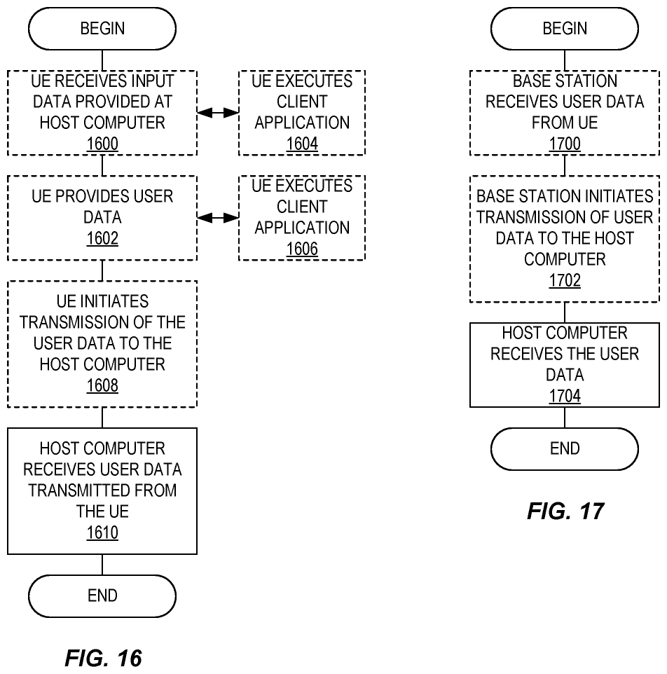

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600 (which may be optional), the UE receives input data provided by the host computer. Additionally or alternatively, in step 1602, the UE provides user data. In sub-step 1604 (which may be optional) of step 1600, the UE provides the user data by executing a client application. In sub-step 1606 (which may be optional) of step 1602, the UE executes a client application which provides the user data in reaction to the received input data provided by the host computer. In providing the user data, the executed client application may further consider user input received from the user. Regardless of the specific manner in which the user data was provided, the UE initiates, in sub-step 1608 (which may be optional), transmission of the user data to the host computer. In step 1610 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 (which may be optional), in accordance with the teachings of the embodiments described throughout this disclosure, the base station receives user data from the UE. In step 1702 (which may be optional), the base station initiates transmission of the received user data to the host computer. In step 1704 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments of the present disclosure are as follows.

Embodiment 1: A method performed by a wireless device for enabling New Radio Unlicensed spectrum (NR-U) Configured Uplink with repetition, the method comprising: receiving (500) a configured maximum number of repetitions (repK) and a configured redundancy version (RV) sequence (e.g., via a UE-specific signaling such as, e.g., a UE-specific RRC signaling); and repeating (502) a transport block (TB) corresponding to a PUSCH transmission in accordance to the repK and the configured RV sequence.

Embodiment 2: The method of embodiment 1, wherein repeating the TB comprises starting an initial transmission of the TB at any occasion in a CG-PUSCH window followed by a defined number of repetitions in accordance to the configured RV, wherein the initial transmission of the TB corresponds to RV 0.

Embodiment 3: The method of embodiment 1, wherein repeating the TB comprises applying at least one of the following options when the PUSCH transmission is Type 1 or Type 2 and when the wireless devices is configured to have the repK greater than 1 (repK>1):
repeating the TB across repK consecutive slots within one CG-PUSCH window with identical symbol allocation in each of the repK consecutive slots;
repeating the TB across the repK consecutive slots within the one CG-PUSCH window and across consecutive CG-PUSCH windows with identical symbol allocation in each of the repK consecutive slots;
repeating the TB across repK consecutive PUSCHs within the CG-PUSCH window, wherein all of the repK consecutive PUSCHs are configured to have identical length and in one or more CG-PUSCH transmission periods; and
repeating the TB across repK non-consecutive PUSCHs within one CG-PUSCH window, wherein all of the repK non-consecutive PUSCHs are configured to have identical length with two neighboring PUSCH occasions being separated by a time offset.

Embodiment 4: The method of embodiment 3, wherein repeating the TB further comprises repeating the TB in a same transmission period with configured grant or crossing into a succeeding transmission period.

Embodiment 5: The method of embodiment 1, wherein repeating the TB comprises, for any RV sequence, repeating the TB after one of the following conditions is met:
transmitting K repetitions;
when a UL grant for scheduling the TV is receive with the period; and
an explicit ACK for the TB is received via DFI.

Embodiment 6: The method of embodiment 1, wherein repeating the TB comprises maintaining identical NDI for all of the repK.

Embodiment 7: The method of embodiment 1, wherein repeating the TB comprises starting/restarting a timer when the TB is transmitted/retransmitted, wherein the wireless device may assume NACK and perform non-adaptive retransmission if no ACK is received upon expiration of the timer.

Embodiment 8: The method of embodiment 7, wherein repeating the TB further comprises starting/restarting the timer for a HARQ process in accordance to at least one of the following options:
starting the timer immediately upon first PUSCH repetition transmission and restarting the timer after each subsequent TB repetition transmission;
not starting the timer until last PUSCH repetition transmission;
starting the timer immediately after the last PUSCH repetition transmission within an UL transmission period;
not starting the timer until Nth repetition transmission among the repK (N repK); and
starting the timer after first repetition transmission and upon expiration of a time period.

Embodiment 9: The method of embodiment 1, wherein repeating the TB comprises using a next repetition occasion for retransmission of the TB upon expiration of the timer if the timer and repetition configurations (e.g., repK and repK-RV) are configured and the timer is started/restarted after the TB.

Embodiment 10: A wireless device for enabling New Radio Unlicensed spectrum (NR-U) Configured Uplink with repetition, the wireless device comprising:
processing circuitry configured to perform any of the steps of any of the embodiments; and
power supply circuitry configured to supply power to the wireless device.

Embodiment 11: A User Equipment, UE, for enabling New Radio Unlicensed spectrum (NR-U) Configured Uplink with repetition, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 12: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the embodiments.

Embodiment 13: The communication system of the previous embodiment, wherein the cellular network further includes a base station configured to communicate with the UE.

Embodiment 14: The communication system of the previous 2 embodiments, wherein:
the processing circuitry of the host computer is configured to execute a host application, thereby providing the user data; and
the UE's processing circuitry is configured to execute a client application associated with the host application.

Embodiment 15: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the embodiments.

Embodiment 16: The method of the previous embodiment, further comprising at the UE, receiving the user data from the base station.

Embodiment 17: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the embodiments.

Embodiment 18: The communication system of the previous embodiment, further including the UE.

Embodiment 19: The communication system of the previous 2 embodiments, further including the base station, wherein the base station comprises a radio interface configured to communicate with the UE and a communication interface configured to forward to the host computer the user data carried by a transmission from the UE to the base station.

Embodiment 20: The communication system of the previous 3 embodiments, wherein:
the processing circuitry of the host computer is configured to execute a host application; and
the UE's processing circuitry is configured to execute a client application associated with the host application, thereby providing the user data.

Embodiment 21: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 22: A method implemented in a communication system including a host computer, a base station, and a User Equipment, UE, the method comprising:
at the host computer, receiving user data transmitted to the base station from the UE, wherein the UE performs any of the steps of any of the embodiments.

Embodiment 23: The method of the previous embodiment, further comprising, at the UE, providing the user data to the base station.

Embodiment 24: The method of the previous 2 embodiments, further comprising:
at the UE, executing a client application, thereby providing the user data to be transmitted; and
at the host computer, executing a host application associated with the client application.

Embodiment 25: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 26: A method implemented in a communication system including a host computer, a base station, and a User Equipment, UE, the method comprising:—
at the host computer, receiving, from the base station, user data originating from a transmission which the base station has received from the UE, wherein the UE performs any of the steps of any of the embodiments.

Embodiment 28: The method of the previous embodiment, further comprising at the base station, receiving the user data from the UE.

Embodiment 29: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgement
AMF Access and Mobility Function
AP Access Point
ASIC Application Specific Integrated Circuit
AUSF Authentication Server Function
CCA Clear Channel Assessment
CCE Control Channel Element
CORESET Control Resource Set
CPU Central Processing Unit
DCI Downlink Control Information
DFI Downlink Feedback Information
DMRS Demodulation Reference Signal
DSP Digital Signal Processor
eMBB Enhanced Mobile Broadband
eNB Enhanced or Evolved Node B
E-UTRA Evolved Universal Terrestrial Radio Access
FPGA Field Programmable Gate Array
gNB New Radio Base Station
gNB-DU New Radio Base Station Distributed Unit
HARQ Hybrid Automatic Repeat Request
HSS Home Subscriber Server
IoT Internet of Things
LBT Listen-Before-Talk
LTE Long Term Evolution
MAC Medium Access Control
MME Mobility Management Entity
MTC Machine Type Communication
NACK Negative Acknowledgment
NDI New Data Indicator
NEF Network Exposure Function
NF Network Function
NR New Radio
NRF Network Function Repository Function
NSSF Network Slice Selection Function
OFDM Orthogonal Frequency Division Multiplexing
OTT Over-the-Top
PBCH Physical Broadcasting Channel
PC Personal Computer
PCF Policy Control Function
PDCCH Physical Downlink Control Channel
PDSCH Physical Downlink Shared Channel
P-GW Packet Data Network Gateway
PRACH Physical Random Access Channel
PRB Physical Resource Block
PUSCH Physical Uplink Shared Channel
RAM Random Access Memory
RAN Radio Access Network
RAR Random Access Response
RB Resource Block
REG Resource Element Group
RMSI Remaining Minimum System Information
ROM Read Only Memory
RRC Radio Resource Control
RRH Remote Radio Head
RT Redundancy Version
SCEF Service Capability Exposure Function
SMF Session Management Function
SPS Semi-Persistent Scheduling
TB Transport Block
TXOP Transmission Opportunity
UCI Uplink Control Information
UDM Unified Data Management
UE User Equipment
UPF User Plane Function
URLLC Ultra-Reliable and Low Latency Communication

Those skilled in the art will recognize improvements and modifications to the embodiments of the present disclosure. All such improvements and modifications are considered within the scope of the concepts disclosed herein.

1. A method performed by a wireless device for enabling Configured Uplink with repetition, the method comprising:
receiving a configured number of repetitions; and
repeating a Transport Block, TB, corresponding to a Physical Uplink Shared Channel, PUSCH, transmission across an equal number of consecutive PUSCHs as the configured number of repetitions, wherein all of the consecutive PUSCHs have an identical length and fall within one or more Configured Grant-PUSCH, CG-PUSCH, transmission periods.

2. The method of claim 1, wherein:
receiving the configured number of repetitions further comprises receiving a Redundancy Version, RV; and
repeating the TB corresponding to the PUSCH transmission comprises repeating the TB corresponding to the PUSCH transmission across the consecutive PUSCHs that fall within one CG-PUSCH transmission period.

3. The method of claim 2, wherein repeating the TB corresponding to the PUSCH transmission comprises starting an initial transmission of the TB at any occasion in the CG-PUSCH transmission period followed by the configured number of repetitions in accordance to the RV.

4. The method of claim 3, wherein the initial transmission of the TB corresponds to RV value zero, 0.

5. The method of claim 1, wherein repeating the TB corresponding to the PUSCH transmission further comprises repeating the TB when the configured grant is signaled via at least one of Radio Resource Control, RRC, signaling and Layer 1, L1, signaling and the configured number of repetitions is greater than one.

6. The method of claim 1, wherein repeating the TB corresponding to the PUSCH transmission further comprises terminating the repetition of the TB corresponding to the PUSCH transmission in response to meeting one of the following conditions:
repeating the TB corresponding to the PUSCH transmission for the configured number of repetitions;
receiving an uplink grant for scheduling the TB within the CG-PUSCH transmission period; and
receiving an explicit Acknowledgement for the TB.

7. The method of claim 1, wherein repeating the TB corresponding to the PUSCH transmission further comprises maintaining an identical New Data Indicator, NDI, across the configured number of repetitions.

8. The method of claim 1, wherein repeating the TB corresponding to the PUSCH transmission further comprises:
starting/restarting a timer when the TB is transmitted or retransmitted; and
performing non-adaptive retransmission in response to not receiving an Acknowledgement at an expiration of the timer.

9. The method of claim 8, wherein starting/restarting the timer comprises starting/restarting the timer in accordance with one or more of the following options:
starting the timer immediately upon a first PUSCH repetition transmission and restarting the timer after each subsequent PUSCH repetition transmission;
not starting the timer until a last PUSCH repetition transmission;
starting the timer immediately after the last PUSCH repetition transmission within the CG-PUSCH transmission period;
not starting the timer until there is a specific number of PUSCH repetition transmissions among the configured number of repetitions; and
starting the timer after the first PUSCH repetition transmission after expiration of a time period.

10. The method of claim 8, further comprising using a next repetition among the configured number of repetitions for retransmission of the TB upon the expiration of the timer.

11. A wireless device for enabling Configured Uplink with repetition, the wireless device comprising:
processing circuitry configured to cause the wireless device to:
receive a configured number of repetitions;
repeat a Transport Block, TB, corresponding to a Physical Uplink Shared Channel, PUSCH, transmission across an equal number of consecutive PUSCHs as the configured number of repetitions, wherein all of the consecutive PUSCHs have an identical length and fall within one or more Configured Grant-PUSCH, CG-PUSCH, transmission periods; and
power supply circuitry configured to supply power to the wireless device.

12. A method performed by a base station for enabling Configured Uplink with repetition, the method comprising:
providing a configured number of repetitions to a wireless device; and
receiving, from the wireless device, repetition of a Transport Block, TB, corresponding to a Physical Uplink Shared Channel, PUSCH, transmission across an equal number of consecutive PUSCHs as the configured number of repetitions, wherein all of the consecutive PUSCHs have an identical length and fall within one or more Configured Grant-PUSCH, CG-PUSCH, transmission periods.

13. The method of claim 12, wherein:
providing the configured number of repetitions comprises providing a Redundancy Version, RV; and
receiving repetition of the TB corresponding to the PUSCH transmission comprises receiving the TB corresponding to the PUSCH transmission across the consecutive PUSCHs that fall within one CG-PUSCH transmission period.

14. The method of claim 13, wherein receiving the repetition of the TB corresponding to the PUSCH transmission comprises receiving an initial transmission of the TB at any occasion in the CG-PUSCH transmission period followed by the configured number of repetitions in accordance to the RV.

15. The method of claim 14, wherein the initial transmission of the TB corresponds to RV value zero, 0.

16. The method of claim 12, wherein receiving the repetition of the TB corresponding to the PUSCH transmission further comprises receiving the repetition of the TB when the configured grant is signaled via at least one of Radio Resource Control, RRC, signaling and Layer 1, L1, signaling and the configured number of repetitions is greater than one.

17. The method of claim 12, wherein receiving the repetition of the TB corresponding to the PUSCH transmission further comprises stopping receiving the repetition of the TB corresponding to the PUSCH transmission in response to meeting one of the following conditions:
receiving the repetition of the TB from the wireless device for the configured number of repetitions;
providing an uplink grant to the wireless device for scheduling the TB within the CG-PUSCH transmission period; and
providing an explicit Acknowledgement to the wireless device for the TB.

18. The method of claim 12, wherein receiving the repetition of the TB corresponding to the PUSCH transmission further comprises receiving an identical New Data Indicator, NDI, across the configured number of repetitions.

19. A base station for enabling Configured Uplink with repetition, the base station comprising:
a control system configured to cause the base station to:
provide a configured number of repetitions to a wireless device; and
receive, from the wireless device, repetition of a Transport Block, TB, corresponding to a Physical Uplink Shared Channel, PUSCH, transmission across an equal number of consecutive PUSCHs as the configured number of repetitions, wherein all of the consecutive PUSCHs have an identical length and fall within one or more Configured Grant-PUSCH, CG-PUSCH, transmission periods.
